(19) United States
(12) Patent Application Publication
(10) Pub. No.: US 2026/0089558 A1
(43) Pub. Date: Mar. 26, 2026

(54) MANAGING EXTENDED REALITY TRAFFIC IN RADIO ACCESS NETWORKS

(71) Applicant: Apple Inc., Cupertino, CA (US)

(72) Inventors: Neha Goel, Herndon, VA (US); Sudeep Manithara Vamanan, Uttenreuth (DE)

(21) Appl. No.: 18/891,301

(22) Filed: Sep. 20, 2024

(51) Int. Cl. H04W 28/06; H04W 72/044

(52) U.S. Cl. CPC H04W 28/06; H04W 72/044

(57) ABSTRACT

Disclosed are methods, systems, and computer-readable medium to perform operations including: generating a protocol data unit (PDU) burst comprising a set of frames, wherein the set of frames comprises a combination of one or more predictive frames (P-frames), one or more intra-coded frames (I-frames), or both; determining, based on the combination of P-frames, I-frames, or both, information indicating one or more characteristics of the PDU burst. The operations also include transmitting the information indicating the one or more characteristics of the PDU burst to a base station; and receiving, from the base station, a message indicating an allocation of an amount of network resources for the PDU burst.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

To transmit video data efficiently, wireless communication networks can use video compression. Video compression can decrease an amount of space required to transmit video data by reducing redundancy between consecutive frames, with intra-coded frames (I-frames) and predicted frames (P-frames) playing key roles. An I-frame is a fully self-contained image that does not rely on other video frames. P-frames, on the other hand, store only the changes from the preceding I-frame or another P-frame. This means that P-frames are significantly smaller in size as compared with I-frames. Predictive video coding using P-frames and I-frames allows for efficient video compression, decreasing data usage while maintaining video quality.

### SUMMARY

This disclosure describes systems and methods for generating a protocol data unit (PDU) burst and determining information corresponding to the PDU burst so that a radio access network (RAN) can allocate network resources. One aspect of the subject matter described in this specification may be embodied in a user equipment (UE) comprising one or more processors and a memory storing instructions that when executed by the one or more processors, cause the UE to perform operations comprising: generating a protocol data unit (PDU) burst comprising a set of frames, wherein the set of frames comprises a combination of one or more predictive frames (P-frames), one or more intra-coded frames (I-frames), or both; and determining, based on the combination of P-frames, I-frames, or both, information indicating one or more characteristics of the PDU burst. The operations also comprise transmitting the information indicating the one or more characteristics of the PDU burst to a base station; and receiving, from the base station, a message indicating an allocation of an amount of network resources for the PDU burst.

In some implementations, the operations further comprising sending the PDU burst to the base station in response to the message indicating the allocation of the amount of network resources for the PDU burst.

In some implementations, determining the information indicating the one or more characteristics of the PDU burst comprises: determining, based on generating the set of frames to include P-frames, I-frames, or both, a type of the PDU burst; and determining the information indicating the one or more characteristics of the PDU burst based on the type of the PDU burst.

In some implementations, determining the type of the PDU burst comprises: determining that the PDU burst is a first type based on generating the PDU burst to include P-frames without including any I-frames; determining that the PDU burst is a second type based on generating the PDU burst to include a combination of I-frames and P-frames, the I frames refreshing according to a key refresh rate; and determining that the PDU burst is a third type based on generating the PDU burst to include a combination of I-frames and P-frames, the I-frames for correcting errors in the P-frames.

In some implementations, the set of frames comprises one or more PDU sets, wherein each PDU set of the one or more PDU sets comprises P-frames or I-frames, and wherein determining the type of the PDU burst comprises: determining that the PDU burst is the first type based on all of the one or more PDU sets including P-frames; determining that the PDU burst is the second type based on the one or more PDU sets including a first PDU set of P-frames, which is arranged before a PDU set of I-frames, which is arranged before a second PDU set of P-frames; and determining that the PDU burst is the third type based on the one or more PDU sets including a first PDU set of P-frames, which is arranged before a second PDU set of P-frames, which is arranged before a PDU set of I-frames.

In some implementations, the PDU burst comprises a sequence of PDU sets each including one or more frames of the set of frames, and wherein determining the information comprises one or more of: determining whether each PDU set of the sequence of PDU sets includes P-frames or I-frames; determining a size of each PDU set of the sequence of PDU sets in bytes; and determining a priority of each PDU set of the sequence of PDU sets relative to a priority of other PDU sets of the sequence of PDU sets.

In some implementations, transmitting the information to the base station indicates to the base station the amount of network resources to allocate based on one or more of: whether each PDU set of the sequence of PDU sets includes P-frames or I-frames; the size of each PDU set of the sequence of PDU sets; and the priority of each PDU set of the sequence of PDU sets relative to the priority of other PDU sets of the sequence of PDU sets.

In some implementations, applying the model comprises: applying a first size determination model based on determining that the PDU burst is the first type; applying a second size determination model based on determining that the PDU burst is the second type; and applying a third size determination model based on determining that the PDU burst is the third type.

In some implementations, the first size determination model represents a minimum burst size, wherein the second size determination model represents an average burst size, and wherein the third size determination model represents a maximum burst size.

In some implementations, the message indicating the allocation of the amount of network resources instructs the UE to operate according to one or more discontinuous reception (DRX) configurations, the one or more DRX configurations including connected mode discontinuous reception (CDRX) active mode and CDRX inactive mode.

In some implementations, receiving the message further comprises: receiving, based on the message instructing the UE to operate according to the CDRX active mode, a physical downlink control channel (PDCCH) wake-up signal indicating that data is to be sent during the CDRX On-duration; or receiving no PDCCH wake-up signal based on the message instructing the UE to operate according to the CDRX inactive mode.

In some implementations, the operations further comprise sending the PDU burst to the base station during the CDRX On-duration based on receiving the PDCCH wake-up signal.

In some implementations, wherein the PDCCH wake-up signal causes the UE to be in an awake state during the CDRX On-duration to send data.

In some implementations, receiving no PDCCH wake-up signal causes the UE to be in an asleep state during the CDRX On-duration.

In some implementations, receiving the message causes the UE to enter a sleep mode.

In some implementations, receiving the message causes the UE to set a modulation and coding scheme (MCS) for the UE based on the allocated amount of network resources.

In some implementations, setting the MCS comprises setting a modulation and a coding rate, wherein the modulation corresponds to a size of the PDU burst and the coding rate corresponds to an amount of the PDU burst relating to error correction.

Another aspect of the subject matter described in this specification may be embodied in a base station comprising: one or more processors; and memory storing instructions that when executed by the one or more processors, cause the base station to perform operations comprising: receiving, from a user equipment (UE), information indicating one or more characteristics of a protocol data unit (PDU) burst, wherein the one or more characteristics indicate an amount of network resources to allocate for the PDU burst, wherein the PDU burst comprises a set of frames, and wherein the set of frames comprises one or more predictive frames (P-frames), one or more intra-coded frames (I-frames), or a combination of P-frames and I-frames; determining, based on the information indicating the one or more characteristics of the PDU burst, an amount of network resources to allocate for the PDU burst; and transmitting, to the UE, a message indicating an allocation of the amount of network resources for the PDU burst, the amount of network resources based on the one or more characteristics of the PDU burst.

In some implementations, the operations further comprise receiving the PDU burst in response to transmitting the message indicating the allocation of the amount of network resources for the PDU burst.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network.

FIG. 2 and FIG. 3 each illustrate a flowchart of an example method.

FIG. 4 illustrates examples of three types of protocol data unit (PDU) bursts involving one or both of predicted frames (P-frames) and intra-coded frames (I-frames).

FIG. 5 illustrates an example user equipment (UE).

FIG. 6 illustrates an example access node.

### DETAILED DESCRIPTION

While connected to a wireless network, a user equipment (UE) can stream and upload video content. Uploading and streaming video content often involves data sizes that are significantly larger than data sizes associated with other network usages such as text messaging, voice calling, and web browsing. Bandwidth can become limited in wireless networks as more UEs connect to these networks and consume data. This means that wireless networks manage data consumption to account for many UEs interacting with the network at the same time. Because video uploading and streaming consumes a large amount of data, the network can allocate an appropriate amount of network resources to UEs that engage in video streaming usages. This is especially true when a UE connects to the network for an extended reality (XR) video application. XR encompasses immersive technologies such as virtual reality (VR), augmented reality (AR), and mixed reality (MR). These technologies often involve real-time interactive video content that can include virtual video data, real world video data, or virtual video data overlain on real world video data. Consequently, XR applications can consume even a greater amount of bandwidth as compared with ordinary video streaming.

This disclosure describes systems and methods for assisting a wireless network in allocating resources for XR video applications. As described below, a UE can generate video data including one or more protocol data unit (PDU) bursts. These PDU bursts include video frames that are compressed to convey video data in a smaller data size as compared with non-compressed video data. Because wireless networks are better able to accommodate compressed video data as compared with non-compressed video data, UEs that generate PDU bursts for XR applications can improve an ability of the wireless network to handle XR traffic as compared with UEs that do not generate PDU bursts to compress video data. A PDU burst, in some examples, includes predicted frames (P-frames), intra-coded frames (I-frames), or a combination of P-frames and I-frames. Because an I-frame is a fully self-contained image and P-frames store changes from other frames, P-frames can be useful for compressing video data to accommodate limited bandwidth because P-frames are significantly smaller than I-frames.

When a UE generates a PDU burst, the UE can determine information associated with the PDU burst that is helpful to the radio access network (RAN) in allocating network resources for the PDU burst. For example, PDU bursts vary in size depending on the kinds of frames included therein. As described, P-frames are significantly smaller than I-frames. This means that PDU bursts that exclusively include P-frames are often smaller as compared with PDU bursts that include a combination of P-frames and I-frames. Furthermore, the context in which I-frames are used in a PDU burst affects the size of the PDU burst. For example, when I-frames are merely used to correct errors in P-frames, this can result in smaller PDU frames as compared with examples where I-frames are relied upon for a key refresh rate. The UE can analyze these and other characteristics of the PDU burst to determine an overall size of the PDU burst and send this information to the RAN. The RAN can use the information to determine an amount of resources to allocate to the UE for transmitting the PDU burst and send a response indicating the amount of allocated resources. Based on receiving this response, the UE can send the PDU burst to the UE. Additionally, or alternatively, the RAN can use the information to regulate power consumption of the UE.

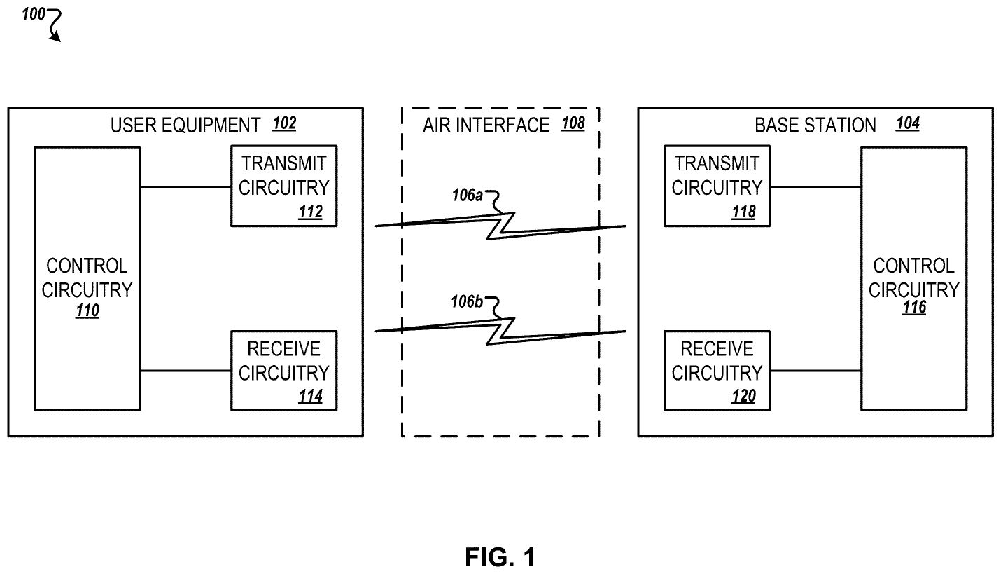

FIG. 1 illustrates a wireless network 100. The wireless network 100 includes a UE 102 and a base station 104 connected via one or more channels 106A, 106B (collectively, “channels 106”) across an air interface 108. The UE 102 and base station 104 communicate using a system that supports controls for managing the access of the UE 102 to a network via the base station 104. In some examples, the UE 102 can connect to the base station 104 to use one or more XR applications or other video data applications. In some examples, these applications involve sending video data to base station 104 and/or receiving video data from base station 104 via channels 106 across the air interface 108. For example, user equipment 102 can generate video data and output information relating to the video data to base station 104. This allows base station 104 to allocate network resources for UE 102 to transmit the video data in a way that accommodates UE 102's video use over the network.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), smart television, video game console, XR device (such as an XR headsets), wearable device (such as a smart watch), intelligent transportation system, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For instance, the control circuitry 110 can generate video data, determine information corresponding to video data, receive data and information from base station 104, and process the data and information received from base station 104 to determine one or more actions. To generate video data for XR applications, control circuitry 110 can generate one or more PDU bursts that represent video data compressed for transmission over air interface 108 to base station 104.

A PDU burst refers to a sequence of video frames. These video frames can be compressed to improve efficiency by decreasing an amount of data required to convey video information and to reduce latency in video streaming. One way that PDU bursts can compress video data is incorporating P-frames or a combination of P-frames and I-frames so that video data is reduced from full image frames. Because P-frames are smaller than I-frames, the UE 102 can compress video data by generating PDU bursts that exclusively include these smaller P-frames or include a combination of P-frames and I-frames.

I-frames (Intra-coded frames) contain a complete image of a video frame, fully independent of any other frames. For example, when a video is not compressed, each frame of the video is similar to an I-frame in that it conveys a complete view of the video at a point in time within the video. Consequently, I-frames are similar to still images, in that I-frames store all of the spatial data needed to recreate a scene at a particular moment within the video. In some examples, an I-frame includes a complete grid of pixels, with each pixel having an intensity value and/or a color value. This means that I-frames can include details such as color, brightness, and texture for each pixel without relying on information from prior or subsequent frames. Because I-frames convey a complete image and are not compressed based temporal considerations, I-frames are larger in size as compared with other frames such as P-frames.

P-frames indicate differences or changes in an image from a preceding frame (e.g., preceding I-frame or preceding P-frame) in the PDU burst. For instance, instead of storing an entire still image, P-frames use motion compensation and prediction techniques to encode parts of a frame that have changed from the previous frame. For example, when a video depicts an object moving across a stationary background, the pixels corresponding to the stationary background do not significantly change throughout the video, but the pixels corresponding to the object change as the object moves. The UE 102 can generate P-frames that convey pixel changes corresponding to the object movement without including the non-changing background pixels in each frame. Consequently, by using P-frames to track changes without repeating constant data, the UE can generate PDU bursts that convey the same video information but are significantly smaller than frame sequences that repeat constant pixels in each consecutive frame.

Although P-frames can be advantageous for video compression due to their small size, there are also a number of drawbacks to P-frames. For example, because P-frames rely on preceding I-frames or P-frames for data reconstruction, this means that corruption in prior I-frames or P-frames frames can propagate to subsequent P-frames. For example, if a prior frame includes corruption or other errors, a subsequent P-frame can propagate these errors and/or corruption. In some examples, a frame within a PDU burst can be lost in transmission completely, which can lead to difficulty in using subsequent P-frames to reconstruct the video because the subsequent P-frames are reliant on the missing frame for context. Furthermore, in video applications where dynamic error correction is important such as in XR applications, P-frames are not as useful as I-frames for performing error correction because I-frames can reset the reference image for subsequent P-frames after an error in a previous frame whereas P-frames refer back to an erroneous frame. Control circuitry 110 can, in some examples, generate PDU bursts based on these competing considerations of data compression and video quality.

In some examples, one or more I-frames and/or P-frames in a PDU burst can serve as a long-term reference (LTR) frame. LTR frames can be used in PDU bursts as a reference for a longer duration, such as for hundreds or thousands of subsequent frames. LTR frames can improve compression frequency especially when scenes are repeated or contain similar content over long period of time. This means that LTR frames can decrease an amount of encoding required to compress video data as compared with systems that do not use LTR frames. LTR frames can be any type of frame (I-frame, P-frame, or other type of frame). One reason that LTR frames improve compression efficiency is that LTR frames not have to be encoded repeatedly because one single LTR frame serves as a reference for many subsequent frames.

In some examples, UE 102 can generate one or more PDU bursts based on characteristics of the connection between UE 102 and base station 104. The PDU burst can include a set of frames. For example, UE 102 can generate a PDU burst including exclusively P-frames, exclusively I-frames, or a combination of P-frames and I-frames. PDU bursts that include exclusively P-frames are generally smaller than PDU bursts that include exclusively I-frames or a combination of P-frames and I-frames because P-frames are significantly smaller in size than I-frames. This means that it can be beneficial for UE 102 to generate PDU bursts including exclusively P-frames because this decreases the amount of data required to convey video information as compared with generating PDU bursts that include I-frames. However, as described above, P-frames can introduce and propagate errors throughout video data that decreases a quality of the reconstructed video. In some embodiments, UE 102 can assess a quality of the connection between UE 102 and base station 104 (e.g., based on cell condition information received from the base station 104) and use this information in determining the content of PDU frames.

In some implementations, UE 102 can determine a quality of the channels 106 over which UE 102 transmits video data to base station 104 and/or receives video data from base station 104. In some examples, UE 102 can determine the quality of the channels 106 based on signaling from base station 104. When channels 106 are higher quality, this means that channels 106 can support PDU burst transmission without introducing a high volume of errors into the PDU burst. On the other hand, when channels 106 are lower quality, a higher volume of errors can be introduced when channels 106 convey PDU bursts. Error can be introduced in a number of ways including data alteration, delayed frames, and dropped frames. In some examples, UE 102 can determine the quality of channels 106 to assess an extent to which error correction is necessary to properly convey video information in a PDU burst. In other examples, UE 102 can determine whether error correction is necessary based on feedback (e.g., NACK) received from base station 104.

For example, when the channels 106 over which UE 102 transmits video data to base station 104 are of higher quality, this means that UE 102 can generate PDU bursts including exclusively P-frames or generate PDU bursts including many P-frames and few I-frames. This is because when channels 106 are high-quality, UE 102 can send a PDU burst to base station 104 including exclusively or mostly P-frames without transmission errors introducing errors that propagate through P-frames, negatively affecting the quality of reconstructed video data. By generating PDU bursts that are largely or completely populated by P-frames, UE 102 can decrease an amount of data necessary to convey video information and therefore decrease a likelihood that transmission of the PDU burst will overwhelm the network.

In cases where the channels 106 over which UE 102 transmits video data to base station 104 are of lower quality, UE 102 can generate PDU bursts that include a combination of P-frames and I-frames. The I-frames in the combination can serve to correct errors in other frames throughout the transmission or generally provide more context that improves an ability of base station 104 or another entity to reconstruct the video data even when errors are introduced during transmission. PDU bursts that include a combination of P-frames and I-frames can be larger than PDU bursts that exclusively include P-frames, however, which means that UE 102 consumes a greater amount of network resources to transmit a combination of P-frames and I-frames as compared with the amount of resources required to transmit exclusively P-frames.

In some examples, XR traffic can include multiple data streams comprising multiple data flows with different traffic characteristics. Each of these flows can have different packet sizes, component streams, and cadences. For example, each data flow can be configured separately according to periodicity, packet size distribution, and data flow-specific latency and reliability requirements. Data flows in XR traffic, in some examples, can include one or more PDU bursts. These one or more PDU bursts can each include, for example, one or more PDU sets. A PDU set comprises one or more PDUs each carrying the payload of one unit of information generated at the application level (e.g., a frame or video slice). In some examples, periodic traffic can come in larger burst sizes in XR traffic. High reliability and low latency in XR traffic can decrease network capacity and a number of XR users that can be reliably served. This is because transmitting XR traffic with high reliability and low latency demands a greater amount of network resources as compared with transmitting XR traffic with lower reliability and lower latency. Base station 104 can manage the network to accommodate a large number of XR users by allocating network resources to each user.

PDU sets and PDU bursts can enable a RAN (e.g., via base station 104) to identify the PDUs which carry content that the application processes as a single unit. These units also allow the RAN to determine a duration of a data transmission. A RAN can receive information about XR applications and traffic characteristics such as data burst size to assist the RAN to increase capacity and increase power saving gains. For example, UE 102 can determine the size of a PDU burst, the size of each PDU set within a PDU burst, or a packet delay budget for a given PDU burst or PDU set and UE 102 can transmit this information to base station 104. Using this information, base station 104 can schedule and allocate network resources in a way that increases total network capacity.

In some implementations, UE 102 generates PDU bursts to include one or more PDU sets. A PDU burst includes a set of frames. Each PDU set of the one or more PDU sets includes one or more frames of the set of frames. In some examples, each PDU set of the one or more PDU sets includes exclusively P-frames or exclusively I-frames. UE 102 can, in some examples, generate the PDU burst including the one or more PDU sets such that the one or more PDU sets are arranged in order of priority. For example, in a PDU set including exclusively P-frames, control circuitry 110 can generate the PDU burst so that each PDU set includes one or more P-frames associated with a region within the video. The PDU sets can be arranged within the PDU burst according to priority, with regions corresponding to greater change assigned a higher priority and regions corresponding to lower change assigned a lower priority. This means that P-frames associated with regions where the video is changing extensively appear near the beginning of the PDU set and P-frames associated with regions where the video not changing significantly appear at the end of the PDU set.

UE 102 can also organize PDU bursts including a mixture of P-frames and I-frames according to priority. For example, in examples where UE 102 determines to generate a PDU burst with a combination of I-frames and P-frames, the I-frames used for error correction due to a lower quality connection between UE 102 and base station 104, UE 102 can generate PDU bursts to include one or more PDU sets of P-frames at the beginning of the PDU burst and one or more PDU sets of I-frames at the end of the PDU burst. The PDU sets of P-frames can be arranged in order of priority with the most changing regions assigned the highest priority. The one or more PDU sets of I-frames at the end of the PDU burst can correct any errors that may have propagated through the P-frames at the beginning of the PDU burst. Additionally, in some examples, UE 102 can generate a PDU burst that includes one or more PDU sets of I-frames preceded by one or more PDU sets of P-frames and followed by one or more PDU sets of P-frames.

The transmit circuitry 112 can perform various operations described in this specification. For example, based on control circuitry 110 generating a PDU burst, control circuitry 110 can cause transmit circuitry 112 to transmit information to base station 104 via the channels 106 of air interface 108, the information indicating one or more characteristics of the PDU burst. In some cases, the transmit circuitry 112 can transmit one or more PDU bursts generated by control circuitry 110 to base station 104. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 108.

The receive circuitry 114 can perform various operations described in this specification. For instance, the receive circuitry 114 can receive data, messages, or other information from base station 104. In some examples, receive circuitry 114 can receive one or more messages from base station 104 indicating an amount of network resources allocated for video traffic (e.g., a PDU burst). In some examples, receive circuitry 114 can receive one or more messages from base station 104 comprising instructions to occupy a configuration, go to sleep, perform one or more other actions, or any combination thereof. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

In some examples, based on generating a PDU burst comprising a set of frames, UE 102 can determine information indicating one or more characteristics of the PDU burst. This information, also called PDU Set Information, can include information relating to a size of the PDU burst, PDU Set Sequence Number, Indication of End PDU of the PDU Set, PDU Sequence Number within a PDU Set, PDU Set Size in bytes, and PDU Set Importance (which identifies the relative importance of a PDU Set compared to other PDU Sets within a QoS Flow). For example, UE 102 can determine whether each PDU set of the sequence of PDU sets in the PDU burst includes P-frames or I-frames, determine a size of each PDU set of the sequence of PDU sets in bytes, and determine a priority of each PDU set of the sequence of PDU sets relative to a priority of other PDU sets of the sequence of PDU sets. Because the P-frame and I-frame content of each PDU set is indicative of the size of each PDU set, this information can allow the UE 102 to determine a size of the PDU burst. In some examples, UE 102 can convey a size of the PDU burst to base station 104 using transmit circuitry 112.

UE 102 can, in some examples, determine a packet delay budget corresponding to a PDU burst and include this packet delay budget in the information indicating the one or more characteristics of the PDU burst. In some examples, the packet delay budget corresponding to the PDU burst represents a maximum allowable delay for packets to traverse channels 106 from UE 102 to base station 104. It is important for the network to be able to meet the packet delay budget of the PDU burst, so UE 102 determining the packet delay budget and including this value in the information can assist the base station 104 in allocating resources for the PDU burst. Using the packet delay budget, the base station 104 can allocate network resources such that packets of the PDU burst can traverse the network between UE 102 and base station 104 within the packet delay budget.

To determine a size of a PDU burst, in some examples, UE 102 can determine a type of the PDU burst and apply a model to determine the size of the PDU burst based on the type of the PDU burst. As described above, some PDU bursts exclusively include P-frames and some PDU bursts include a mixture of P-frames and I-frames. PDU bursts that exclusively include P-frames represent a first type of PDU burst. PDU bursts that include a mixture of P-frames and I-frames, with the I-frames used to refresh at a constant rate represent a second type of PDU burst. PDU bursts that include a mixture of P-frames and I-frames, with the I-frames used to correct errors represent a third type of PDU burst. Generally, PDU bursts of the first type are smaller than PDU bursts of the second and third types. Additionally, PDU bursts of the third type are smaller than the second type and larger than PDU bursts of the first type. PDU bursts of the second type are the largest of the three types. In some cases, UE 102 applies a model to determine the size of the PDU burst based on the type of the PDU burst. The size of the PDU burst can be transmitted to the base station 104 using the transmit circuitry 112.

The most beneficial model for determining the size of a PDU burst can depend on the type and content of the PDU burst. For example, the size of a PDU burst can vary based on frame type (e.g., P-frame vs. I-frame) and frame priority. I-frame arrival, for instance, can be aperiodic and I-frames are significantly larger in size than P-frames. PDU bursts that include I-frames supported at a frequent refresh rate can improve XR video quality, but PDU bursts including frequently refreshed I-frames can be much larger in size than PDU bursts exclusively including P-frames. P-frames can have an associated priority and thus a PDU burst can store information within the priority of P-frames. Burst length can vary for each PDU burst depending on which PDU sets and frames are sent at high priority. Other factors that can determine the size of a PDU burst include radio conditions, radio and MCS allocation, and cell load.

As described above, to determine the size of the PDU burst, UE 102 can apply the model. The model for determining the size of the PDU burst can include a set of size determination models including a first size determination model representing a minimum burst size, a second size determination model representing an average burst size, and a third size determination model representing a maximum burst size. In some examples, the minimum burst size represents a minimum size of the PDU burst in bytes over a set time interval or window (e.g., five seconds or any other time interval) within the PDU burst. In some examples, the average burst size represents an average (e.g., mean) size of the PDU burst in bytes over a set time interval (e.g., five seconds or any other time interval) within the PDU burst. In some examples, the maximum burst size represents a maximum size of the PDU burst in bytes over a set time interval (e.g., five seconds or any other time interval) within the PDU burst. For example, the minimum burst size of a PDU burst within a five second window can represent the smallest amount of data in bytes of the PDUs within that five second window. The average burst size of a PDU burst within a five second window can represent the mean amount of data in bytes within of the PDUs that fall within that window. The maximum burst size of a PDU burst lasting within a five second window can represent the greatest amount of data in bytes of the PDUs within that window. The window is not limited to being 5 seconds long and can be different value.

The first size determination model representing the minimum burst size can be given by equation 1, where n represents a window size (e.g., 5 seconds) and x[i], x[i−1], and so on represent the size in bytes of the PDU burst during each time interval within the window, where a PDU instance occurs during each time interval.

$$min \{ x [ i ] , x [ i − 1 ] , … x [ i − n + 1 ] \} \qquad ( eq . 1 )$$

The second size determination model representing the average burst size can be given by equation 2, where n represents a window size (e.g., 5 seconds) and x[i], x[i−1], and so on represent the size in bytes of the PDU burst during each time interval within the window.

$$\frac{\{ x [ i ] , x [ i − 1 ] , … x [ i − n + 1 ] \}}{\{ n \}} \qquad ( eq . 2 )$$

The third size determination model representing the maximum burst size can be given by equation 3, where n represents a window size (e.g., 5 seconds) and x[i], x[i−1], and so on represent the size in bytes of the PDU burst during each time interval within the window.

$$max \{ x [ i ] , x [ i − 1 ] , … x [ i − n + 1 ] \} \qquad ( eq . 3 )$$

The first size determination model (equation 1), in some examples, is suitable for determining a size of a PDU burst that exclusively includes P-frames. Because P-frames are significantly smaller in size than I-frames, the minimum burst size can be helpful for determining a minimum amount of bandwidth required to support the PDU burst(s) that occur(s) within the specified window. In some cases, because P-frames are small, the maximum and average burst sizes for a PDU burst including exclusively P-frames might not be significantly greater than the minimum burst size for this PDU burst. Consequently, the minimum burst size can be effective for determining the burst size of a PDU burst including exclusively P-frames. The second size determination model (equation 2), in some examples, is suitable for determining a size of a PDU burst that includes dynamic I-frames and P-frames. Because I-frames and P-frames are significantly different in size (I-frames are much larger than P-frames) and spread out through a dynamic PDU burst, the average burst size can serve as a good estimate of the size of the PDU burst. The third size determination model (equation 3), in some examples, is suitable for determining a size of a PDU burst that includes a PDU set of I-frames and remaining P-frames. This is because the part of the PDU burst that includes I-frames will be significantly larger than the parts of the PDU burst including P-frames. As a result, the maximum burst size is the best estimate for the size of the PDU burst. As described above, one or more P-frames and/or I-frames can represent an LTR frame. The first size determination model, the second size determination model, and the third size determination model can be applied when one or more of the P-frames and/or I-frames in the PDU burst represent an LTR frame.

The information that UE 102 generates to indicate characteristics of a PDU burst can assist the base station 104 in allocating network resources. For example, if UE 102 generates a larger PDU burst, a greater amount of network resources can be required for UE 102 to transmit the PDU burst to base station 104 and if UE 102 generates a smaller PDU burst, a smaller amount of network resources can be required for UE 102 to transmit the PDU burst to base station 104. This means that it can be beneficial for UE 102 to determine the information corresponding to the PDU burst and transmit this information to the base station 104 so that base station 104 can effectively allocate network resources to handle the PDU burst. Base station 104 can, for example, process the information sent by UE 102 and determine an amount of network resources to allocate to UE 102. Receive circuitry 114 of UE 102 can receive a message from base station 104 and perform one or more actions to comply with the allocation of network resources. This can improve a performance of the network, allowing a greater number of UEs to interact with base station 104 seamlessly and without disruption to video uses.

FIG. 1 also illustrates the base station 104. In some implementations, the base station 104 may be a 5G RAN, a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

The base station 104 can perform several actions to allocate network resources to UE 102 based on information received from UE 102 indicating characteristics of a PDU burst. For example, information indicating the size of the PDU burst and/or the size of one or more PDU sets within the PDU burst can indicate to the base station 104 an amount of network resources to allocate for transmission of the PDU burst. In some examples, a greater amount of resources can be allocated for larger PDU bursts and a smaller amount of resources can be allocated for smaller PDU bursts.

In some examples, the information that UE 102 sends to base station 104 can include a packet delay budget for a PDU set generated by UE 102. A packet delay budget is a specified limit on the amount of time that a packet can be delayed as it travels through a network from the source to its destination. The packet delay budget can ensure that the packet reaches its destination within an acceptable time frame to meet quality of service (QoS) requirements, especially for time-sensitive applications like real-time video streaming, XR video streaming, VoIP, or online gaming. If the delay exceeds the packet delay budget, a quality of the service can degrade. This can result in issues such as lag, jitter, or dropped packets. Packet delay budget can be used in network planning to balance latency with other performance factors such as throughput and packet loss.

Base station 104 can determine an amount of network resources to allocate for UE 102 to transmit the PDU burst based on the packet delay budget for the PDU burst. In some examples, smaller PDU bursts will have greater packet delay budgets, meaning that packets can be delayed more without compromising video quality. Conversely, larger PDU bursts will have smaller packet delay budgets, meaning that packets cannot be delayed as much without compromising video quality. In some examples, base station 104 can allocate more network resources for PDU bursts that have smaller packet delay budgets as compared with resources allocated for PDU bursts that have larger packet delay budgets.

One way that base station 104 allocates network resources is by selecting one or more configurations that UEs occupy. These configurations include discontinuous reception (DRX) configurations such as the connected mode discontinuous reception (CDRX) active mode and the CDRX inactive mode. CDRX is a power-saving feature used in some 3GPP networks to reduce the power consumption and data consumption of UEs by controlling how often they wake up to receive data from the network. CDRX causes UEs to alternate between active phases when data transmission occurs and inactive phases when data transmission does not occur. Two important modes in CDRX include the CDRX active mode and the CDRX inactive mode.

During the active mode of CDRX, the UE remains connected to the network and monitors a downlink for incoming data from the network. The On-duration is a brief window when the device checks for any data transmissions. In other words, the UE stays awake during the On-duration, ready to receive data if and when it arrives. If data is received during the On-duration, the device remains active for the duration of the transmission, ensuring timely delivery of packets with minimal delay. After the On-duration window expires and if no data is received, the device enters an inactive phase. In the inactive phase, the UE reduces its power consumption by temporarily discontinuing its active monitoring of the network. The UE can, in some examples, wake up periodically or when triggered by specific network conditions, leading to extended battery life. The device stays inactive until the next scheduled On-duration phase or if a data transmission is initiated. During the inactive mode of CDRX, the UE can remain asleep without periodically waking up during On-durations of CDRX. These modes allow for a balance between efficient data transmission and power conservation, with the UE periodically checking for data but staying inactive when no communication is needed.

Based on the PDU burst size indicated by the information received by base station 104 from UE 102, the base station 104 can determine whether to cause UE 102 to operate according to one or more CDRX modes. For example, base station 104 can send a physical downlink control channel (PDCCH) wake up signal to the UE 102, indicating to the UE 102 that PDCCH is to be transmitted during the CDRX On-duration. This effectively represents a signal to UE 102 to operate according to the active mode of CDRX where data transmission occurs during the On-duration. If base station 104 does not send a PDCCH wake-up signal to UE 102 in response to receiving the information corresponding to the PDU burst, this can indicate to UE 102 to remain asleep during the CDRX On-duration and thus operate according to the inactive mode of CDRX. Base station 104 can, in some examples, control a length of the CDRX On-duration based on the information indicating characteristics of the PDU burst.

In any case, based on receiving information indicating characteristics of a PDU burst from UE 102 via receive circuitry 120, base station 104 can transmit a message to UE 102 via transmit circuitry 118 that indicates an allocation of an amount of network resources for the PDU burst. This can cause UE 102 to transmit the PDU burst to base station 104 over air interface 108. Base station 104 can receive the PDU burst over air interface 108. In some examples, base station 104 can decode the PDU burst, forward the PDU burst to another device, or any combination thereof.

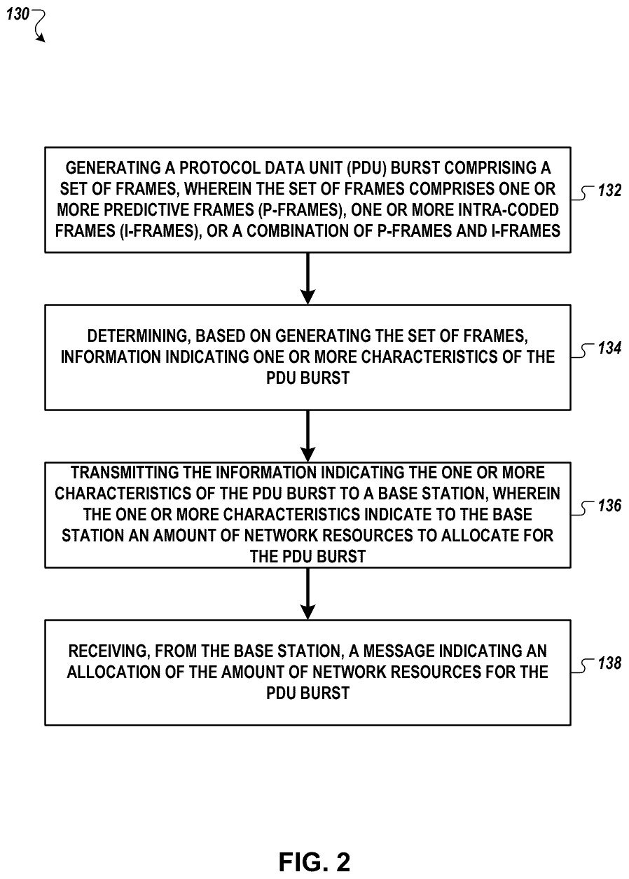

FIG. 2 illustrates a flowchart of an example method 130, according to some implementations. For clarity of presentation, the description that follows generally describes method 130 in the context of the other figures in this description. For example, method 130 can be performed by UE 102 of FIG. 1. It will be understood that method 130 can be performed, for example, by any suitable system, environment, software, hardware, or a combination of systems, environments, software, and hardware, as appropriate. In some implementations, various steps of method 130 can be run in parallel, in combination, in loops, or in any order.

In some examples, UE 102 can generate a PDU burst comprising a set of frames, where the set of frames comprises one or more P-frames, one or more I-frames, or a combination of P-frames and I-frames (132). This set of frames can include, in some examples, one or more PDU sets. Each PDU set of the one or more PDU sets can include, in some examples, exclusively P-frames or exclusively I-frames. The PDU sets can be arranged in order of priority with higher priority PDU sets earlier in the PDU burst and lower priority PDU sets later in the PDU burst. In some examples, UE 102 can generate the PDU burst based on one or more characteristics of channels 106 between UE 102 and base station 104. For example, if the channels 106 between UE 102 and base station 104 are higher quality and not likely to introduce errors in the PDU burst during transmission, UE 102 can generate the PDU burst to include exclusively P-frames. In some examples, if the channels 106 between UE 102 and base station 104 are lower quality, UE 102 can generate the PDU burst to include a combination of P-frames and I-frames. The I-frames can serve to correct errors in other frames or otherwise provide a full frame for reference.

UE 102 can determine, based on generating the set of frames, information indicating characteristics of the PDU burst (134). As described above, the PDU burst can include P-frames, I-frames, or a combination of P-frames and I-frames. UE 102 can determine the P-frame/P-frame content of the PDU burst as part of determining the information indicating one or more characteristics of the PDU burst. In some cases, UE 102 can determine a type of the PDU burst based on whether the set of frames includes P-frames, I-frames, or a combination of P-frames and I-frames. For example, UE 102 can determine that the PDU burst is a first type based on generating the PDU burst to include P-frames without including any I-frames. UE 102 can determine that the PDU burst is a second type based on generating the PDU burst to include a combination of I-frames and P-frames, the I frames refreshing according to a key refresh rate. UE 102 can determine that the PDU burst is a third type based on generating the PDU burst to include a combination of I-frames and P-frames, the I-frames for correcting errors in the P-frames.

As described above, the second type and the third type can both include a mixture of I-frames and P-frames. The third type can differ from the second type in that the third type involves a PDU set of I-frames for correcting errors at the end of the PDU burst, with two or more PDU sets of P-frames arranged before the PDU set of I-frames, whereas the second type involves a PDU set of I-frames between PDU sets of P-frames. In determining information indicating one or more characteristics of a PDU burst, UE 102 can determine a difference between a PDU burst of the second type and a PDU burst of the third type when the PDU burst includes a mixture of I-frames and P-frames. Generally, PDU bursts of the first type (exclusively P-frames) are smaller in size than PDU bursts of the third type (mixture of I-frames and P-frames), which are smaller in size than PDU bursts of the second type (mixture of I-frames and P-frames). Determining the type of the PDU burst can be beneficial in allocating network resources for the PDU burst because the type is indicative of a general size of the PDU burst, which informs an amount of network resources to allocate for the PDU burst.

In some examples, to determine the information corresponding to the PDU burst, UE 102 can determine whether each PDU set of the sequence of PDU sets includes P-frames or I-frames, determine a size of each PDU set of the sequence of PDU sets in bytes, and determining a priority of each PDU set of the sequence of PDU sets relative to a priority of other PDU sets of the sequence of PDU sets. Whether each PDU set of the sequence of PDU sets includes P-frames or I-frames and the priority of each PDU set can indicate whether the PDU burst is of the first, type, second type, or third type, as described above. The size of each PDU set of the sequence of PDU sets collectively indicates the size of the PDU burst. For example, using this information, UE 102 can determine the type of the PDU burst and the exact size of the PDU burst, meaning that the information can be useful for allocating network resources to accommodate the PDU burst.

UE 102, in some examples, can apply a model to determine a size of the PDU burst generated by UE 102 as part of determining the information indicating the one or more characteristics of the PDU burst in block 134. For example, UE 102 can apply the model to determine the size of the PDU burst based on a type of the PDU burst. For example, the model can include a first size determination model, a second size determination model, and a third size determination model. UE 102 can apply the first size determination model based on determining that the PDU burst is the first type, UE 102 can apply the second size determination model based on determining that the PDU burst is the second type, and UE 102 can apply the third size determination model based on determining that the PDU burst is the third type. In some embodiments, the first size determination model involves determining a minimum burst size over a period of time, wherein the second size determination model involves determining an average burst size over the period of time, and wherein the third size determination involves determining a maximum burst size over the period of time.

UE 102 can transmit the information indicating the one or more characteristics of the PDU burst to base station 104, where the one or more characteristics indicate to base station 104 an amount of network resources to allocate for the PDU burst (136). The information can, in some examples, indicate whether the PDU burst is the first type, the second type, or the third type. In some embodiments, the information can indicate whether each PDU set of a sequence of PDU sets in the PDU burst includes P-frames or I-frames, indicate a size of each PDU set of the sequence of PDU sets, and indicate the priority of each PDU set of the sequence of PDU sets relative to the priority of other PDU sets of the sequence of PDU sets. In some embodiments, the information can indicate a size of the PDU burst generated by UE 102 in bytes. In any case, the information transmitted by the UE 102 to base station 104 allows base station 104 to determine an amount of network resources to allocate for handling transmission of the UE 102.

UE 102 can receive, from base station 104, a message indicating an allocation of the amount of network resources for the PDU burst (138). This allocation of the amount of network resources can be, in some examples, determined by base station 104 based on the information indicating one or more characteristics of the PDU burst determined by UE 102. In some examples, the message indicating the allocation of the amount of network resources instructs UE 102 to operate according to one or more discontinuous reception (DRX) configurations, the one or more DRX configurations including CDRX active mode (On-duration) and CDRX inactive mode. In some examples, CDRX active mode involves data transmission between UE 102 and base station 104 during a CDRX On-duration. The CDRX inactive mode can involve UE 102 remaining asleep for a configured interval. Whether UE 102 is participating in data transmission during the CDRX On-duration affects an amount of energy consumed by UE 102. Additionally, or alternatively, whether UE 102 is participating in data transmission during the CDRX On-duration affects an amount of network resources consumed by UE 102. Consequently, base station 104 can regulate the power consumption of UE 102 and allocate network resources for transmitting the PDU burst by sending the message to UE 102.

In some embodiments, the message indicating an allocation of the amount of network resources for the PDU burst can include a PDCCH wake-up signal indicating to UE 102 that data is to be sent during the CDRX On-duration. In some embodiments, the message indicating an allocation of the amount of network resources for the PDU burst includes no PDCCH wake-up signal. When the message includes a PDCCH wake-up signal, this can indicate to UE 102 to operate in the CDRX active mode. When the message does not include a PDCCH wake-up signal, this can indicate to UE 102 to operate in the CDRX inactive mode, even during periods that would otherwise be an On-duration mode. Receiving a PDCCH wake-up signal from base station 104 can cause UE 102 to be in an awake state during the CDRX On-duration to send data. Receiving no PDCCH wake-up signal can cause the UE to be in an asleep state during the scheduled CDRX On-duration. Receiving the message from base station 104 can, in some examples, cause UE 102 to enter a sleep mode.

The UE 102 can, in some examples, receive the message from base station 104 which causes UE 102 to set a modulation and coding scheme (MCS) based on the allocated amount of network resources for the PDU burst. The MCS, in some examples, comprises a modulation and coding rate. The modulation corresponds to a size of the PDU burst and the coding rate corresponds to an amount of the PDU burst relating to error correction. This means that the base station 104 can set the MCS of the UE 102 in order to meet the allocated amount of network resources, with greater modulation allocated for larger PDU bursts and greater coding rate allocated for high rates of error correction. Conversely, lower modulation can be allocated for smaller PDU bursts and a lower coding rate can be allocated for low rates of error correction.

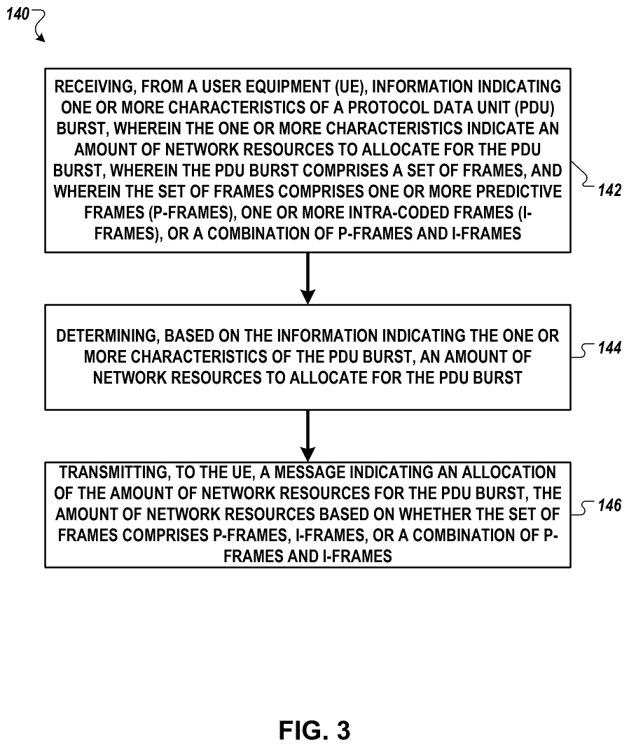

FIG. 3 illustrates a flowchart of an example method 140, according to some implementations. For clarity of presentation, the description that follows generally describes method 140 in the context of the other figures in this description. For example, method 140 can be performed by base station 104 of FIG. 1. It will be understood that method 140 can be performed, for example, by any suitable system, environment, software, hardware, or a combination of systems, environments, software, and hardware, as appropriate. In some implementations, various steps of method 140 can be run in parallel, in combination, in loops, or in any order.

Base station 104 can receive, from UE 102, information indicating one or more characteristics of a PDU bursts, wherein the one or more characteristics indicate an amount of network resources to allocate for the PDU burst, wherein the PDU burst comprises a set of frames, and wherein the set of frames comprises one or more P-frames, one or more I-frames, or a combination of P-frames and I-frames (142). In some examples, the information indicates a size of the PDU burst. In some examples, the information indicates whether the PDU burst is of a first type, a second type, or a third type, where the first type involves PDU bursts of exclusively P-frames and the second and third types involve PDU bursts including a mixture of I-frames and P-frames. In some examples, the information indicates whether each PDU set of the sequence of PDU sets includes P-frames or I-frames, a size of each PDU set of the sequence of PDU sets in bytes, and a priority of each PDU set of the sequence of PDU sets relative to a priority of other PDU sets of the sequence of PDU sets. The information received by base station 104 can include any one or combination of the information described above.

Base station 104 can determine, based on the information indicating the one or more characteristics of the PDU burst, an amount of network resources to allocate for the PDU burst (144). In some examples, the information indicative of the characteristics of the PDU burst represents information that is beneficial for determining an amount of network resources to allocate for the PDU burst, because the type, size, and other characteristics of the PDU burst indicate the amount of resources for effectively transmitting the PDU burst from the UE 102 to the base station 104. For examples, more resources can be allocated for larger PDU bursts and less resources can be allocated for smaller PDU bursts.

In some examples, control circuitry 116 of base station 104 can determine whether to cause UE 102 to operate according to one or more DRX configurations including any one or combination of the CDRX active mode and the CDRX inactive mode. The CDRX active mode involves UE 102 participating in transmission over channels 106 during the CDRX On-duration and the CDRX inactive mode involves UE 102 remaining asleep during the CDRX On-duration. Consequently, base station 104 can control an amount of network resources consumed by UE 102 by controlling an amount of time that UE 102 is communicating with base station 104.

Additionally, or alternatively, base station 104 can cause UE 102 to operate according to a modulating and coding scheme (MCS) based on the information received from the UE 102. The MCS 102 of UE 102 can, in some cases, determine the amount of network resources that UE 102 consumes. This means that by controlling the MCS of UE 102, base station 104 can allocate an amount of network resources to UE 102. For example, an MCS includes a modulation and a coding rate, where the modulation corresponds to a size of the PDU burst and the coding rate corresponds to the amount of the PDU burst relating to error correction. That is, larger PDU bursts can be allocated higher modulation and smaller PDU bursts can be allocated smaller modulation. PDU bursts with higher likely error rate can be allocated a higher coding rate and PDU bursts with lower likely error rate can be allocated a lower coding rate.

Base station 104 can transmit, to UE 102, a message indicating an allocation of the amount of network resources for the PDU burst, the amount of network resources based on whether the set of frames of the PDU burst comprises P-frames, I-frames, or a combination of P-frames and I-frames (146). As described above, the information received from UE 102 can indicate whether the set of frames of the PDU burst comprises P-frames, I-frames, or a combination of P-frames and I-frames in a number of ways. In some examples, the base station 104 can include, in the message indicating the allocation of network resources, the MCS for the UE 102. This MCS can indicate a modulation and a coding rate. In some examples, the base station 104 can include a PDCCH wake-up signal in the message to the UE 102, the PDCCH wake-up signal instructing the UE 102 to operate according to the CDRX active mode. In some examples, the base station 104 can eschew including a PDCCH wake-up signal in the message to the UE 102 to instruct the UE 102 to operate according to the CDRX inactive mode.

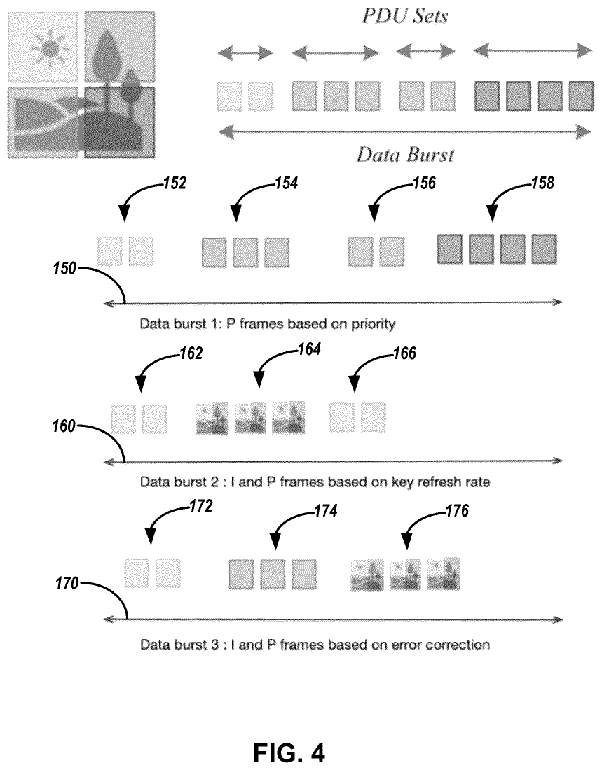

FIG. 4 illustrates examples of three types of PDU bursts involving one or both of P-frames and I-frames. For example, a first type of PDU burst 150 includes a first PDU set of P-frames 152, a second PDU set of P-frames 154, a third PDU set of P-frames 156, and a fourth PDU set of P-frames 158. The PDU sets are arranged in order of priority with the first PDU set of P-frames 152 having the highest priority and the fourth PDU set of P-frames 158 having the lowest priority. The second type of PDU burst 160 includes a first PDU set of P-frames 162, a PDU set of I-frames 164, and a second PDU set of P-frames 166. The PDU set of I-frames may, in some examples, refresh at a key refresh rate. The third type of PDU burst 170 includes a first PDU set of P-frames 172, a second PDU set of P-frames 174, and a PDU set of I-frames 176. The PDU set of I-frames may, in some examples, serve to correct errors introduced in the frames. I-frames are greater in size than P-frames. This means that the first type of PDU burst 150 is smaller in size than the second type of PDU burst 160 and the third type of PDU burst 170. In some examples, the second type of PDU burst 160 is greater in size than the third type of PDU burst 170.

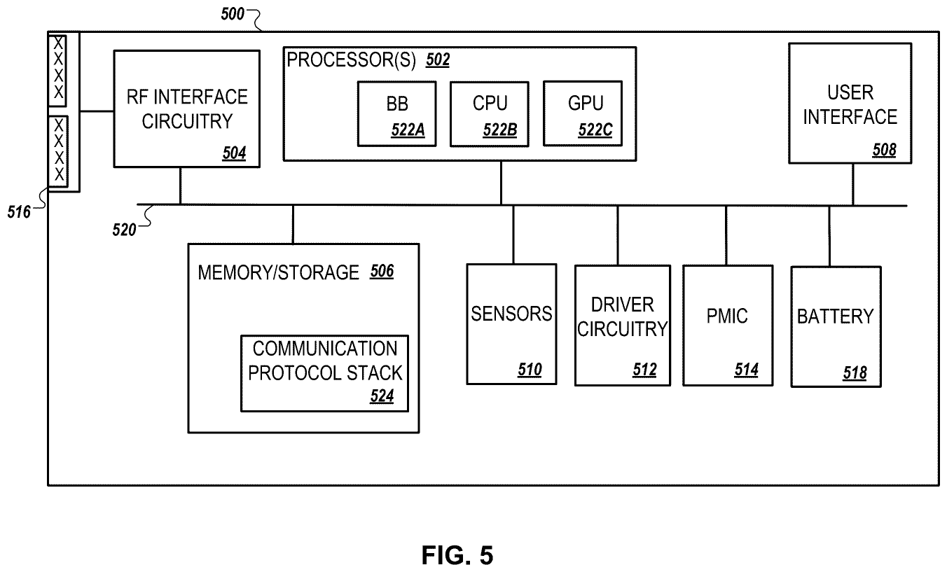

FIG. 5 illustrates an example UE 500. The UE 500 may be similar to and substantially interchangeable with UE 102 of FIG. 1.

The UE 500 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 500 may include any/all of processor 502, RF interface circuitry 504, memory/storage 506, user interface 508, sensors 510, driver circuitry 512, power management integrated circuit (PMIC) 514, one or more antenna(s) 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and a different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc., that allows various circuit components (on common or different chips or chipsets) to interact with one another.

The processor 502 may include one or more processors. For example, the processor 502 may include processor circuitry such as, for example, baseband processor circuitry (BB) 522A, central processor unit circuitry (CPU) 522B, and graphics processor unit circuitry (GPU) 522C. The processor 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by the processor 502 to cause the UE 500 to perform various operations described herein. The memory/storage 506 include any type of volatile or non-volatile memory that may be distributed throughout the UE 500. In some implementations, some of the memory/storage 506 may be located on the processor 502 itself (for example, L1 and L2 cache), while other memory/storage 506 is external to the processor 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 516 and proceed to filter and amplify (with a low-noise amplifier) the signal. The signal may be provided to a receiver of the transceiver that down-converts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 516. In various implementations, the RF interface circuitry 504 may be configured to transmit/receive signals in a manner compatible with NR access technologies.

The antenna(s) 516 may include one or more antenna elements to convert electrical signals into radio waves to travel through the air and to convert received radio waves over the air into electrical signals. In some implementations, the antenna elements may be arranged into one or more antenna panels. The antenna(s) 516 may have antenna panels that are omnidirectional, directional, or a combination thereof, to enable beamforming and multiple input, multiple output communications. The antenna(s) 516 may include any/all of microstrip antennas, printed antennas fabricated on the surface of one or more printed circuit boards, patch antennas, phased array antennas, etc. The antenna(s) 516 may have one or more panels designed for one or more specific frequency bands, such as bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensors 510 and control and allow access to sensors 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processor 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

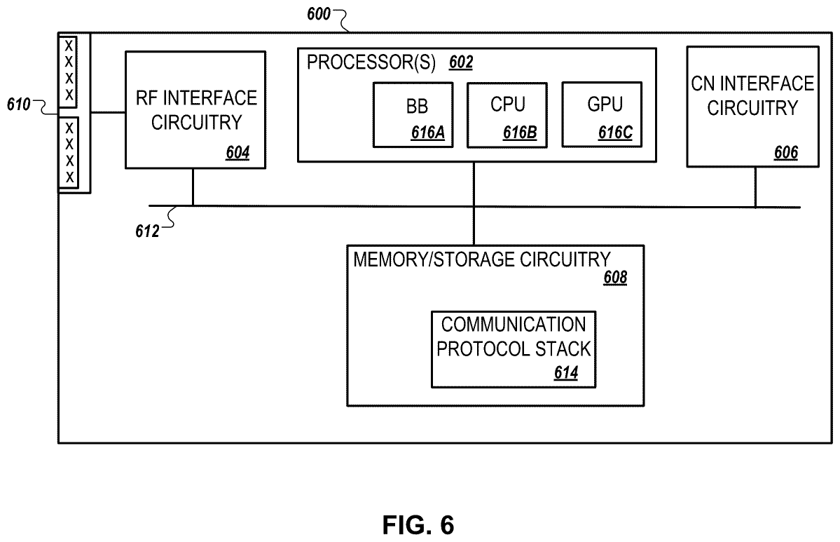

FIG. 6 illustrates an example access node 600 (e.g., a base station or gNodeB (gNB)), according to some implementations. The access node 600 may be similar to and substantially interchangeable with base station 104. The access node 600 may include one or more of processor 602, RF interface circuitry 604, core network (CN) interface circuitry 606, memory/storage circuitry 608, and one or more antenna(s) 610. The processor 602 may include any type of circuitry or processor circuitry that executes or otherwise operates computer-executable instructions, such as program code, software modules, or functional processes from memory/storage circuitry 608 to cause the access node 600 to perform operations as described herein.

The components of the access node 600 may be coupled with various other components over one or more interconnects 612. The processor 602, RF interface circuitry 604, memory/storage circuitry 608 (including communication protocol stack 614), antenna(s) 610, and interconnects 612 may be similar to like-named elements shown and described with respect to FIG. 5. For example, the processor 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

The 5GC network is implemented on one or more computing systems and can include several Network Functions (NFs) that work together to deliver the capabilities of 5G. The 5GC network includes an Access and Mobility Management Function (AMF), which manages user registration, connection, and mobility. The 5GC network also includes a Session Management Function (SMF) that oversees session establishment and IP address allocation. Additionally, the 5GC network includes a Network Slice Selection Function (NSSF) that enables the 5GC to support network slicing, allowing the creation of virtual networks. A Policy Control Function (PCF) of the 5GC enforces quality of service (QoS) and access policies, ensuring that network resources are allocated according to predefined rules.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A user equipment (UE) comprising:
one or more processors; and
memory storing instructions that when executed by the one or more processors, cause the UE to perform operations comprising:
generating a protocol data unit (PDU) burst comprising a set of frames, wherein the set of frames comprises a combination of one or more predictive frames (P-frames), one or more intra-coded frames (I-frames), or both;
determining, based on the combination of P-frames, I-frames, or both, information indicating one or more characteristics of the PDU burst;
transmitting the information indicating the one or more characteristics of the PDU burst to a base station; and
receiving, from the base station, a message indicating an allocation of an amount of network resources for the PDU burst.

2. The UE of claim 1, the operations further comprising sending the PDU burst to the base station in response to the message indicating the allocation of the amount of network resources for the PDU burst.

3. The UE of claim 1, wherein determining the information indicating the one or more characteristics of the PDU burst comprises:
determining, based on generating the set of frames to include P-frames, I-frames, or both, a type of the PDU burst; and
determining the information indicating the one or more characteristics of the PDU burst based on the type of the PDU burst.

4. The UE of claim 3, wherein determining the type of the PDU burst comprises:
determining that the PDU burst is a first type based on generating the PDU burst to include P-frames without including any I-frames;
determining that the PDU burst is a second type based on generating the PDU burst to include a combination of I-frames and P-frames, the I frames refreshing according to a key refresh rate; and
determining that the PDU burst is a third type based on generating the PDU burst to include a combination of I-frames and P-frames, the I-frames for correcting errors in the P-frames.

5. The UE of claim 4, wherein the set of frames comprises one or more PDU sets, wherein each PDU set of the one or more PDU sets comprises P-frames or I-frames, and wherein determining the type of the PDU burst comprises:
determining that the PDU burst is the first type based on all of the one or more PDU sets including P-frames;
determining that the PDU burst is the second type based on the one or more PDU sets including a first PDU set of P-frames, which is arranged before a PDU set of I-frames, which is arranged before a second PDU set of P-frames; and
determining that the PDU burst is the third type based on the one or more PDU sets including a first PDU set of P-frames, which is arranged before a second PDU set of P-frames, which is arranged before a PDU set of I-frames.

6. The UE of claim 1, wherein the PDU burst comprises a sequence of PDU sets each including one or more frames of the set of frames, and wherein determining the information comprises one or more of:
determining whether each PDU set of the sequence of PDU sets includes P-frames or I-frames;
determining a size of each PDU set of the sequence of PDU sets in bytes; and
determining a priority of each PDU set of the sequence of PDU sets relative to a priority of other PDU sets of the sequence of PDU sets.

7. The UE of claim 6, wherein transmitting the information to the base station indicates to the base station the amount of network resources to allocate based on one or more of:
whether each PDU set of the sequence of PDU sets includes P-frames or I-frames;
the size of each PDU set of the sequence of PDU sets; and
the priority of each PDU set of the sequence of PDU sets relative to the priority of other PDU sets of the sequence of PDU sets.

8. The UE of claim 1, wherein the determining the information comprises:
determining whether the PDU burst is a first type, a second type, or a third type; and
applying a model to determine a size of the PDU burst based on whether the PDU burst is the first type, the second type, or the third type, the size of the PDU burst indicating the amount of network resources to allocate for the PDU burst.

9. The UE of claim 8, wherein applying the model comprises:
applying a first size determination model based on determining that the PDU burst is the first type;
applying a second size determination model based on determining that the PDU burst is the second type; and
applying a third size determination model based on determining that the PDU burst is the third type.

10. The UE of claim 9, wherein the first size determination model represents a minimum burst size, wherein the second size determination model represents an average burst size, and wherein the third size determination model represents a maximum burst size.

11. The UE of claim 1, wherein the message indicating the allocation of the amount of network resources instructs the UE to operate according to one or more discontinuous reception (DRX) configurations, the one or more DRX configurations including connected mode discontinuous reception (CDRX) active mode and CDRX inactive mode.

12. The UE of claim 11, wherein receiving the message further comprises:
receiving, based on the message instructing the UE to operate according to the CDRX active mode, a physical downlink control channel (PDCCH) wake-up signal indicating that data is to be sent during a CDRX On-duration; or
receiving no PDCCH wake-up signal based on the message instructing the UE to operate according to the CDRX inactive mode.

13. The UE of claim 12, the operations further comprising sending the PDU burst to the base station during the CDRX On-duration based on receiving the PDCCH wake-up signal.

14. The UE of claim 12, wherein the PDCCH wake-up signal causes the UE to be in an awake state during the CDRX On-duration to send data.

15. The UE of claim 12, wherein receiving no PDCCH wake-up signal causes the UE to be in an asleep state during the CDRX On-duration.

16. The UE of claim 1, wherein receiving the message causes the UE to enter a sleep mode.

17. The UE of claim 1, wherein receiving the message causes the UE to set a modulation and coding scheme (MCS) for the UE based on the allocated amount of network resources.

18. The UE of claim 17, wherein setting the MCS comprises setting a modulation and a coding rate, wherein the modulation corresponds to a size of the PDU burst and the coding rate corresponds to an amount of the PDU burst relating to error correction.

19. A base station comprising:
one or more processors; and
memory storing instructions that when executed by the one or more processors, cause the base station to perform operations comprising:
receiving, from a user equipment (UE), information indicating one or more characteristics of a protocol data unit (PDU) burst, wherein the one or more characteristics indicate an amount of network resources to allocate for the PDU burst, wherein the PDU burst comprises a set of frames, and wherein the set of frames comprises one or more predictive frames (P-frames), one or more intra-coded frames (I-frames), or a combination of P-frames and I-frames;
determining, based on the information indicating the one or more characteristics of the PDU burst, an amount of network resources to allocate for the PDU burst; and
transmitting, to the UE, a message indicating an allocation of the amount of network resources for the PDU burst, the amount of network resources based on the one or more characteristics of the PDU burst.

20. The base station of claim 19, the operations further comprising receiving the PDU burst in response to transmitting the message indicating the allocation of the amount of network resources for the PDU burst.
